(19) United States
(12) Patent Application Publication
(10) Pub. No.: US 2013/0174482 A1
(43) Pub. Date: Jul. 11, 2013

(54) PLANT POT WITH IRREGULAR BOTTOM EDGE

(71) Applicant: Julie A. GALDI, Wyckoff, NJ (US)

(72) Inventor: Julie A. GALDI, Wyckoff, NJ (US)

(21) Appl. No.: 13/738,177

(22) Filed: Jan. 10, 2013

Related U.S. Application Data
(60) Provisional application No. 61/584,869, filed on Jan. 10, 2012.

(51) Int. Cl. A01G 9/02

(52) U.S. Cl. CPC A01G 9/02
USPC 47/65.7; 47/65.5; 47/66.7

(57) ABSTRACT

A pot for containing a plant such as a flower plant, having a bottom peripheral edge adapted for insertion or installation into a garden bed. In one embodiment, the pot is a normal truncated conical shape and the lower peripheral edge is irregular so as to use that bottom edge to more securely position the pot within a hole in the ground. The irregularity of the lower peripheral edge can be a plurality of teeth that bite into the ground and position the pot in the hole when the user rotates the pot while forcing it downwardly toward the ground. The bottom edge is thus used to cause the pot to settle firmly within the hole dug in the ground. In another embodiment, the pot is empty and is installed in the garden to provide decoration, by positioning the pot against the garden bed, and then pushing the pot into place. The upper rim of the pot may be decorative and may be located above the level of the ground.

### RELATED APPLICATIONS

The present application claims the benefit under 35 U.S.C. §119 of U.S. Provisional Application Ser. No. 61/584,869 filed Jan. 10, 2012. The contents of said provisional application are hereby incorporated by reference in its entirety.

### BACKGROUND OF INVENTION

The present invention relates generally to the area of gardening and particularly to pots containing and displaying plants, including flowers. More particularly, the invention concerns a pot for plants that does not have a bottom associated therewith.

### DESCRIPTION OF THE PRIOR ART

In the area of gardening, and including both indoor and outdoor gardening activities, it is known that plant pots have been and are available at either lack of bottom or a bottom that is removable. Most of the pots for which bottoms are either lacking or are removable, offer such feature to enable the gardener to remove the plant and its surrounding soil with ease. It should be noted that most pots for plants have an open top and tapered vertical side walls, so that diameter of the pot increases from the bottom thereof to the open top. In this connection, therefore, the pot having the removable bottom or lacking a bottom entirely, can be seen to facilitate the ease of removal of the plant from the pot, when such is desired.

In general, plants disposed in self-standing pots of the type described, are usually intended for presentation and location above ground, and often in a nursery, or other structure as well as in the home, office and other habitats and environments. More recently, interest has also developed in the ability for plants in such pots to be disposed in an outdoor environment and particularly, within a garden. In such connection, the gardener likewise wishes to place the pot with the plant and its surrounding soil disposed therein, at least partially into the ground of the garden.

One of the difficulties that has attended the disposition of such pots and plants within an outdoor garden environment, has been the means by which the plant could be easily and securely positioned within the garden. That is, while a hole or the like could be excavated in the garden bed to receive the potted plant, there would remain the stable securement of the plant within the hole following the insertion thereinto. Often, the weather conditions in the outdoor environment are uncertain and frequently turbulent, so that the disposition of the plant within the garden bed could be in jeopardy. Thus, while a closely configured hole could be excavated and the pot with the plant material contained therein could be inserted therein, the exposure of the plant to rain, wind, and the like might dislodge the plant and thereby subject the plant to damage or destruction as a result.

Accordingly, a need is believed to exist for a simple, efficient and secure construction and corresponding procedure whereby potted plants may be disposed in and outdoor environment within a garden and may retain a stable disposition in a secure growing environment and will likewise gain the benefits of the improvement and appearance that often results from disposition in an outdoor growing environment. It is toward the achievement of the afore-noted objectives and objects that the present invention is directed.

### SUMMARY OF THE INVENTION

Accordingly, in a first embodiment, the present invention relates to a pot for a plant such as a flower plant that can be used to secure the position of the pot within a hole dug in the ground.

Thus, the pot of the present invention has means for securing the pot within a hole dug in the ground, comprising a continuous side wall with a lower peripheral edge that has a suitably configured margin or formation, which margin or formation assists in the insertion of the pot into a garden bed, and can be used when inserted in a pre-dug hole in such garden bed, to pass through or remove dirt at either the side walls or the bottom thereof, to thereby stabilize the positioning of the pot within such hole.

In an exemplary embodiment, the irregular margin or formation is a serrated lower edge and may be one or more downwardly directed teeth for engaging and cutting into the ground. In one exemplary embodiment, the teeth are formed around the entire periphery of the lower edge of the flower pot.

As such, with the present invention, the pot preferably containing a plant and surrounding soil therein, can be placed in a pre-dug hole in the ground and then rotated about its longitudinal axis by the user while applying a downward force to cause the teeth to bite into and secure the resting position of the pot within the hole.

In a second embodiment, the plant pot of the invention can be used for purposes of decoration for plants already present in an outside garden. The pot is thereby prepared with a decorative upper rim and a lower margin or formation adapted for insertion into the ground. The pot can be inserted into the ground with the rim facing upward and the margin or formation placed against the garden bed, with installation being made such as by downward pressure applied against the rim to urge the pot into the ground. The pot in this embodiment is likewise visible with the decorative rim thereof facing upward in the garden bed after insertion. Such installation can be made where there is no hole in the ground and also, when the pot is empty, so that the pot provides a decorative frame that surrounds a plant already in the ground.

By using the pot in the manners described, it is assured that the pot is securely located within the hole that has been dug, and will remain stably therein despite adverse outdoor conditions. Likewise, and in the alternative instance where such a pot may be placed in the ground prior to the introduction of a plant and soil thereinto, the same stability is assured.

These and other features and advantages of the present invention will become more readily apparent during the following detailed description taken in conjunction with the drawings herein.

### BRIEF DESCRIPTION OF THE DRAWINGS

FIG. 1 is perspective view of a pot for a plant such as a flower plant, incorporating the present invention;

FIG. 2 is a side view of the pot of FIG. 1 and illustrating the method of the present invention used to secure the pot within a hole in the ground; and

FIG. 3 is a perspective view of a pot in accordance with an alterative embodiment of the invention.

FIG. 4 is a photographic illustration of the pot of FIG. 3 disposed in a garden bed.

### DETAILED DESCRIPTION OF THE INVENTION

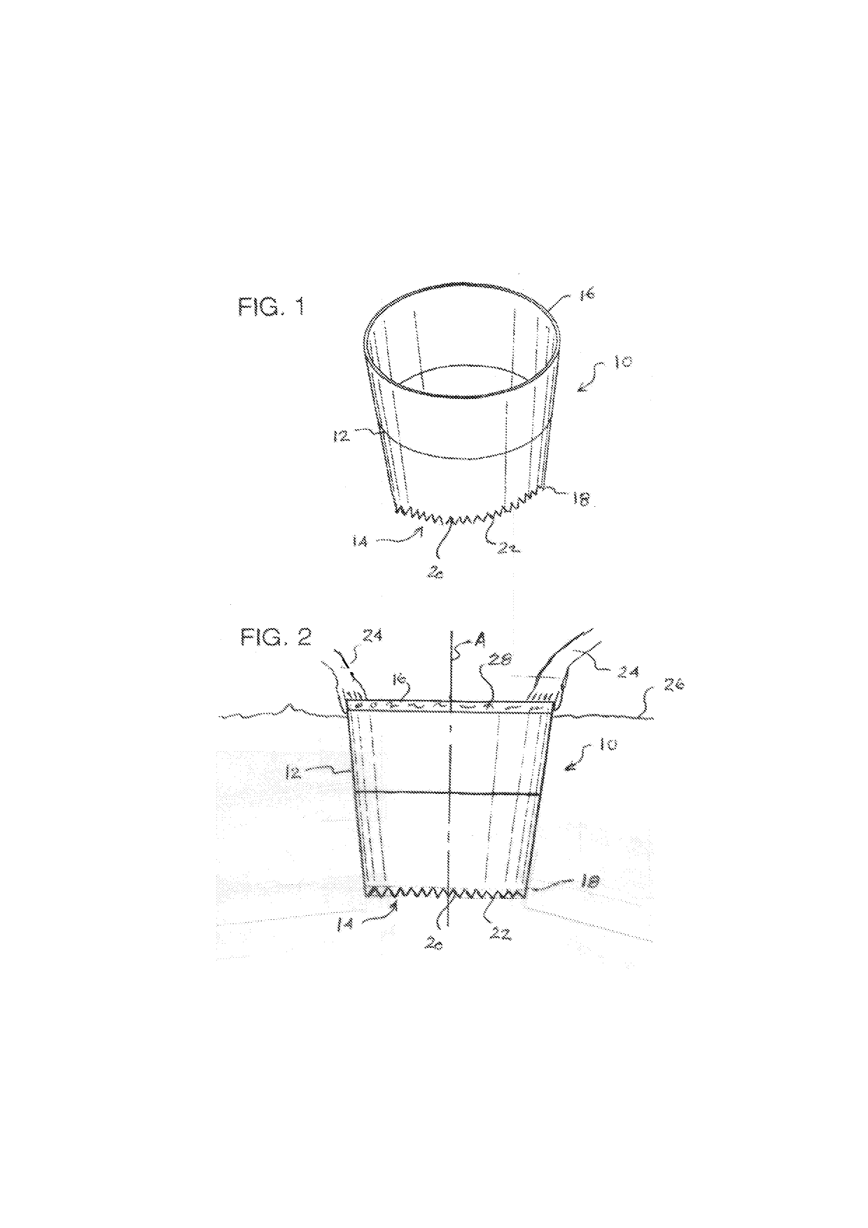

Referring now to FIG. 1, there is shown, a perspective view of a pot 10 constructed in accordance with the present invention. As can be seen, pot 10 is comprised of a continuous side wall 12 and an open bottom 14. As is conventional with the shape of flower pots, the continuous side wall 12 may be a truncated conical shape with a larger diameter top edge 16 and a smaller diameter lower peripheral edge 18.

The lower peripheral edge 18 is designed to be of an irregular shape that enables the lower peripheral edge 18 to be used for the purpose of the present invention, that is, to secure the location of the flower pot 10 within a hole that has been dug in the ground.

In the embodiment of FIG. 1, that irregular shape of the lower peripheral edge 18 is a serrated edge and can include a plurality of v-shaped indentations 20 and downwardly directed v-shaped teeth 22.

As shown, the irregular shape can be provided fully along the entire periphery of the lower peripheral edge 18, or, alternatively, can be discrete irregularities, such as the teeth 22, or groups of teeth 22. It is sufficient that there are enough teeth 22 to carry out the purpose of the presence of the irregular lower peripheral edge 18 as will be later explained.

The pot 10 may be comprised of a variety of materials, such as suitable plastic materials, metals or clay. Particular materials that are contemplated include plastics such as fiberglass, polyurethane and polypropylene, although it should be understood that the invention is not limited by the composition of the material from which the pot is constructed, and all suitable materials are to be included herein.

Turning now to FIG. 2, there is shown a side view of pot 10 of FIG. 1 and illustrating the embodiment where the irregular surface of the lower peripheral edge 18 is comprised of teeth 22 in order to illustrate the method of securing the position of pot 10 within a hole in the garden bed, in accordance with the present invention.

In FIG. 2, therefore, it can be seen that the hands 24 of the user are shown grasping the top edge 16 of the pot 10, and that the pot 10 is submerged beneath the surface of the ground 26 in a hole that has been previously dug for pot 10.

Accordingly, with this position, the user can simply rotate pot 10 about its central longitudinal axis “A” with the use of the hands 24, while exerting a downward force on the pot 10 to secure pot 10 in the ground.

The rotational motion exerted by the hands 22 on the pot 10 may be simply a continual one-direction rotation or may be a back and forth rotation in order to allow the teeth 22 to engage the side walls and bottom of the hole in the ground, and to thereby remove any dirt that may obstruct the desired insertion and securement of pot 10 within the ground.

Again, the present pot 10 and method of using the same can be used to securely embed the pot within the hole previously dug in the ground. As shown, the top edge 16 may remain above the level of the ground and may have a decorative finish 28.

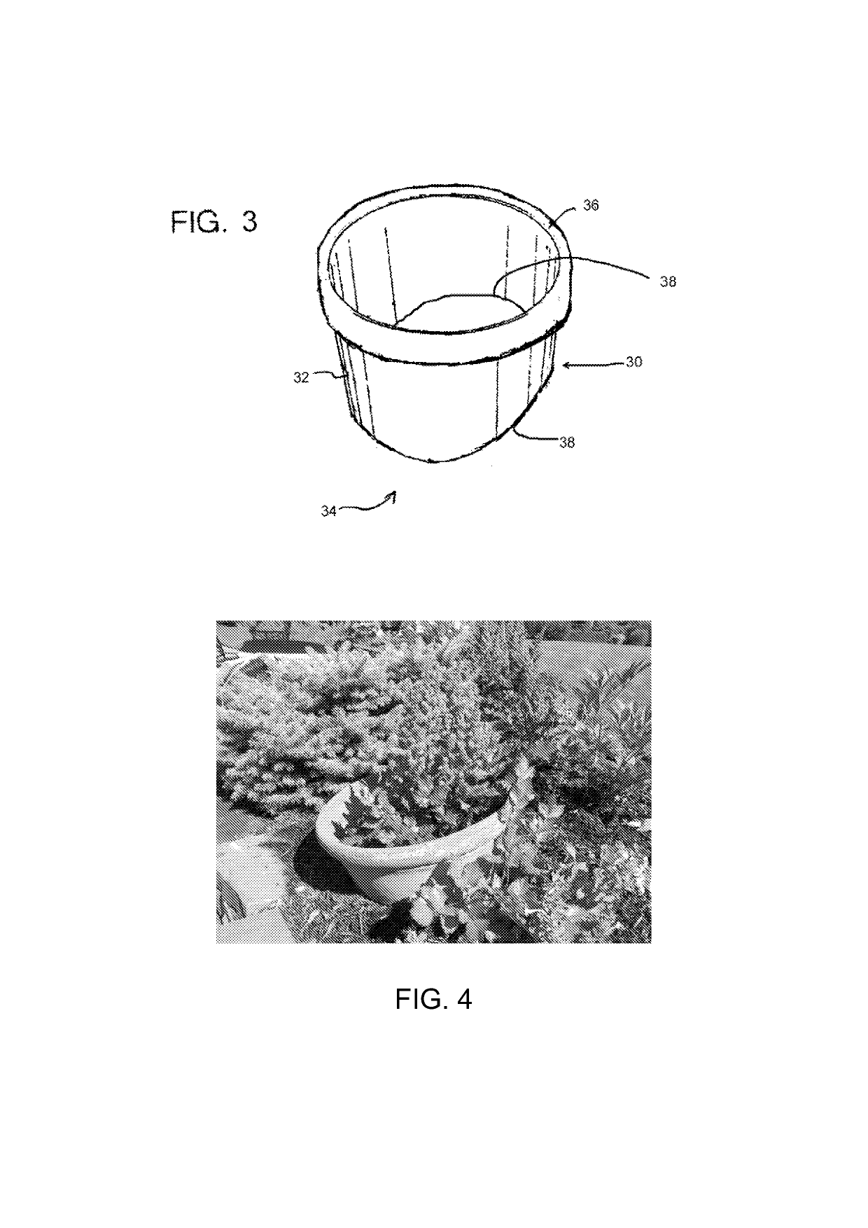

Referring now to FIG. 3, pot 30 is shown that depicts a construction suitable for use as a frame for a plant already in a garden bed. Like pot 10 shown in FIG. 1, pot 30 has a continuous sidewall 32 and an open bottom 34. The lower margin or formation of pot 30, labeled 38, is shown as disposed at a bias or an angle with respect to the plane containing the upper rim or top edge 36, although this configuration is presented by way of non limiting illustration only.

In practice, pot 30 may be lowered or inserted into an existing garden bed so that it frames or surrounds a plant already located and permanently installed in that bed. The biased lower margin or formation permits the placement of the product at an angle to the surface of the bed as well as in a flat or parallel position. The user needs only to place pot 30 in the desired position and orientation for insertion in the ground, and then push pot 30 downward, as by pressure against top edge 36. If desired or required, pot 30 may be rotated about its vertical axis, as is done with pot 10, to assist in the installation. A representative installation of pot 30 in a garden bed is shown in FIG. 4.

Those skilled in the art will readily recognize numerous adaptations and modifications which can be made to the plant pot and method of securing the location of the same in the ground using the pot, that will result in an improved pot and method of using the same, yet all of which will fall within the scope and spirit of the present invention as defined in the following claims. Accordingly, the invention is to be limited only by the following claims and their equivalents.

What is claimed is:

1. A pot for a plant such as a flower, for insertion into a garden bed, having a continuous side wall with a lower peripheral edge, wherein the lower peripheral edge is adapted for insertion into the ground of the garden bed.

2. The pot of claim 1 wherein the lower peripheral edge has an irregular formation suitable for gouging the ground to secure the pot within a hole in the ground.

3. The pot of claim 1, wherein the pot defines a top edge that protrudes from the ground when the pot is installed in the garden bed.

4. The pot of claim 3, wherein the top edge defines a decorative pattern on the outer surface thereof

5. The pot of claim 2, wherein the lower peripheral edge is biased at an angle to the plane containing the top edge.

6. The pot of claim 1 wherein the continuous side wall is a truncated conical shape.

7. The pot of claim 1 wherein the pot is constructed of a plastic material.

8. The pot of claim 1 wherein the pot is constructed from a metal.

9. The pot of claim 1 wherein the pot is constructed from clay.

10. The pot of claim 1 wherein the irregular formation is a serrated edge.

11. The pot of claim 1 wherein the irregular formation comprises at least one downwardly directed v-shaped tooth.

12. The pot of claim 11 wherein the irregular formation comprises a plurality of downwardly directed v-shaped teeth.

13. The pot of claim 1 wherein the irregular formation is formed around the entire periphery of the lower peripheral edge.

14. A method of securing a pot for a plant within a hole in the ground for placement of a plant comprising the steps of:
digging a hole in the ground;
providing a pot having a continuous side wall with a lower peripheral edge, wherein the lower peripheral edge has an irregular formation suitable for digging a hole in the ground;
inserting the pot into the hole in the ground; and
rotating the pot to cause the irregular formation to move the dirt to securely position the pot within the hole in the ground.

15. The method of claim 14 wherein the step of rotating the pot comprises rotating the pot in a back and forth movement.

16. The method of claim 14 wherein the step of rotating the pot comprises rotating the pot in a continuous circular direction.

17. The method of claim 14 wherein the step providing a pot comprises providing a pot wherein the irregular formation comprises serrated teeth.

18. A method for installing the pot of claim 1 in a garden bed and surrounding a plant already located in said bed, comprising providing said pot in the empty condition, placing said pot with the peripheral lower edge against the surface of the garden bed, and then pushing said pot into said garden bed, whereby the top edge of said pot remains visible after installation is complete.

19. The method of claim 18, wherein said pot is positioned to frame a plant already located in said bed, prior to pushing said pot into said bed.
